(19) United States
(12) Patent Application Publication
(10) Pub. No.: US 2024/0141963 A1
(43) Pub. Date: May 2, 2024

(54) Electromechanical Brake and Vehicle

(71) Applicant: Robert Bosch GmbH, Stuttgart (DE)

(72) Inventors: Xiaokun Zhang, Suzhou (CN); Fei Yu, Suzhou (CN)

(21) Appl. No.: 18/492,565

(22) Filed: Oct. 23, 2023

(30) Foreign Application Priority Data
Oct. 27, 2022 (CN) 2022 1132 5946.6

(51) Int. Cl. F16D 65/14; F16H 48/11; F16H 48/34

(52) U.S. Cl. CPC F16D 65/14; F16H 48/11; F16H 48/34; F16D 2121/20

(57) ABSTRACT

The present application provides an electromechanical brake and vehicle. The electromechanical brake includes a first brake motor and a second brake motor, a transmission device linked to the first brake motor and the second brake motor, and a brake actuator linked to the transmission device, with the transmission device transmitting a brake torque of the first brake motor and the second brake motor to the brake actuator. The transmission device includes a differential, with the differential being coupled to the first brake motor and the second brake motor respectively to receive the input torque of the first brake motor and the second brake motor, and output the integrated torque to the brake actuator.

This application claims priority under 35 U.S.C. § 119 to application no. 202211325946.6, filed on 27 Oct. 2022 in China, the disclosure of which is incorporated herein by reference in its entirety.

The present disclosure relates to the field of vehicle brake systems, more particularly, to a novel electromechanical brake and a vehicle with the electromechanical brake.

### BACKGROUND

An electromechanical brake is a device that utilizes an electric motor to actuate the brake caliper for braking. Compared to conventional hydraulic brake systems, it has advantages such as rapid response, simple structure, and ease of maintenance. With the development of vehicle electrification and intelligence, electromechanical brakes have become a development trend of braking systems thanks to their integrability with electric control systems. For electromechanical brakes with the dual-motor system, how to control the operation of each motor is a challenge.

### SUMMARY

The purpose of the present application is to solve or at least alleviate problems existing in the prior art.

Provides an electromechanical brake, including:
a first brake motor and a second brake motor;
a transmission device linked to the first brake motor and the second brake motor; and
a brake actuator linked to the transmission device, with the transmission device transmitting the brake torque from the first brake motor and the second brake motor to the brake actuator;
wherein the transmission device includes a differential, which is coupled to the first brake motor and the second brake motor respectively to receive the input torques from the first brake motor and the second brake motor, and output an integrated torque to the brake actuator.

Further provides a vehicle, including the electromechanical brake according to various embodiments.

### BRIEF DESCRIPTION OF THE DRAWINGS

With reference to the drawings, the content disclosed in the present application is to become understandable more easily. It is readily understood by those skilled in the art that: These drawings are for purposes of illustration only and are not intended to limit the scope of protection of the present application. Further, the similar numerals in the figures are used to represent the similar components, wherein:

FIG. 1 shows an installation diagram of the electromechanical brake according to the embodiment;

FIG. 2 shows a three-dimensional view of the electromechanical brake according to the embodiment;

FIG. 3 shows an exploded view of the electromechanical brake according to the embodiment;

FIG. 4 shows a partial sectional view of the electromechanical brake according to an embodiment;

FIG. 5 shows an exploded view of the electromechanical brake, excluding the brake actuator portion, according to the embodiment;

FIG. 6 shows a three-dimensional view of the internal structure of the brake motor and transmission device of the electromechanical brake according to one embodiment;

FIGS. 7 to 11 show the internal gear structure of a transmission device according to one embodiment from different angles;

FIG. 12 shows the internal structure of the brake motor according to one embodiment;

FIG. 13 shows the partial circuit structure of the electromechanical brake according to one embodiment;

FIG. 14 shows an exploded view of the brake actuator portion of the electromechanical brake according to the embodiment;

FIG. 15 shows a sectional view of the brake actuator portion of the electromechanical brake according to the embodiment;

FIG. 16 shows a three-dimensional view of certain components of the brake actuator of the electromechanical brake according to the embodiment;

FIG. 17 shows a front view of the friction disc bracket and friction disc of the brake actuator of the electromechanical brake according to the embodiment;

FIGS. 18 to 23 show views of the magnet of the rotary position sensor according to various embodiments; and

FIG. 24 shows a schematic diagram of the control structure of the electromechanical brake according to one embodiment;

FIG. 25 shows an exemplary motor characteristic curve; and

FIG. 26 shows an exemplary motor cross-section diagram.

### DETAILED DESCRIPTION

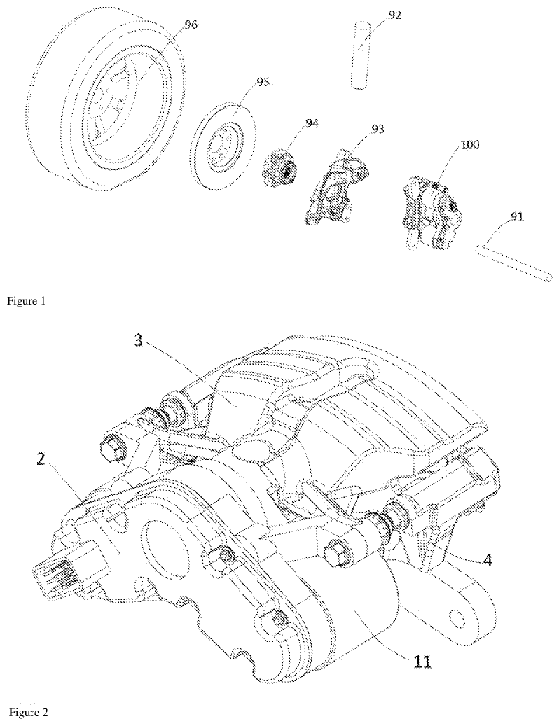

FIG. 1 shows an installation diagram of the electromechanical brake, wherein the diagram shows a rotating shaft 91, a damper 92, a bearing 94, a steering knuckle arm 93, a brake disc 95, and a wheel 96, as well as the electromechanical brake 100 according to the embodiment, which is driven by an electric motor to provide braking force by clamping the brake disc 95 with a brake caliper. During assembly, the electromechanical brake 100 is mounted on the steering knuckle arm 93, and at the same time, is accommodated in a compact space inside the hub of the wheel 96.

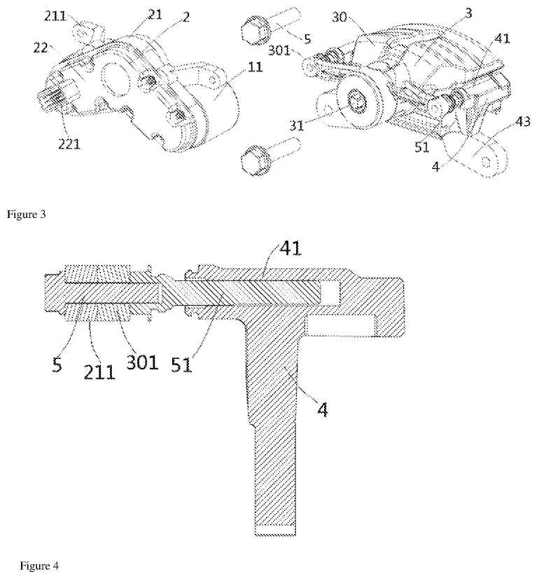

FIG. 2 shows the electromechanical brake according to the embodiment, including a first brake motor 11 and a second brake motor 12 (as shown in FIG. 5); a transmission device 2 linked to the first brake motor 11 and the second brake motor 12; and a brake actuator 3 linked to the transmission device 2. The transmission device 2 couples and transfers the brake torque of the first brake motor 11 and the second brake motor 12 to the brake actuator 3. As shown in the figure, the electromechanical brake includes two brake motors 11 and 12, this electromechanical brake can be used for the main brake wheels, such as the front wheels of a vehicle, that require greater brake torque. For the electromechanical brake on the rear wheels of a vehicle, it can be fitted with only one brake motor, wherein the housing and transmission device 2 are correspondingly modified.

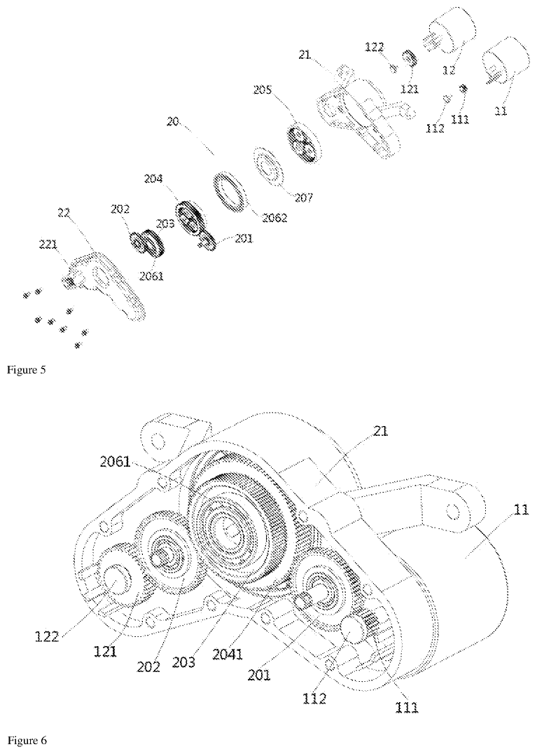

A specific embodiment of the electromechanical brake is hereby described with further reference to FIGS. 3 and 4. In the embodiment shown in FIG. 3, the housing of the transmission device 2 and the brake actuator 3 are separable. The transmission housing and the brake actuator 30 include flanges 211, 301 that define corresponding pairs of bolt holes for connecting the transmission housing and the brake actuator housing 30 together using a pair of bolts 5. Additionally, as shown in FIG. 4, the bolts 5 pass through the flanges 211, 301 of the transmission housing and the brake actuator housing 30 and are received by bolt holes on the back side of a pair of axial guide rods 51, thus allowing axial sliding mounting of the friction disc bracket 4 of the brake actuator 3 on the pair of axial guide rods 51 through a bushing portion 41, thereby realizing relative axial float between the brake actuator housing 30 and the friction disc bracket 4. Finally, the assembled electromechanical brake is installed on the steering knuckle arm 93 shown in FIG. 1 using flanges 43 of the friction disc bracket 4, and the two friction discs on the friction disc bracket 4 are positioned on either side of the brake disc 95.

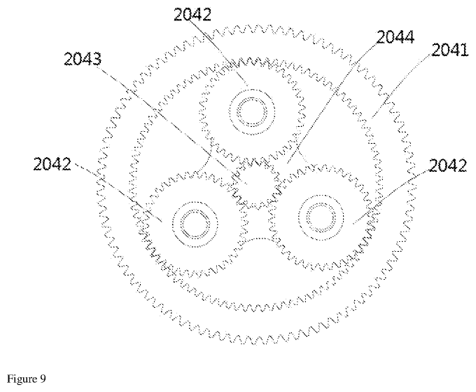

The specific structure of the transmission device 2 of the electromechanical brake is hereby described with further reference to FIGS. 5 to 11. In the embodiments of the present disclosure, a scheme of using a dual-motor system to collaboratively provide output torque is proposed, which is different from the scheme of using a single motor in a dual-motor system in the prior art as a backup motor for another motor. Therefore, it is expected to control the first brake motor 11 and the second brake motor 12 in operate collaboratively to perform various functions. In some common schemes, torque sensors are used to detect the output torque of individual brake motors, thereby controlling the dual-motor system as a whole. However, due to the relatively large size of the torque sensor itself and the relatively large space it occupies, arranging it in the compact space inside the wheel hub is difficult. The present application proposes to set up a differential in the transmission device to integrate the first brake motor 11 and the second brake motor 12, which decouples the first brake motor 11 and the second brake motor 12 to a certain extent, allowing separate control of the first brake motor 11 and the second brake motor 12 by monitoring their respective rotational speeds and currents, thus eliminating the need to monitor the output torque of the first brake motor 11 and the second brake motor 12 individually.

As shown in the figure, the transmission housing may be composed of a first housing portion 21 and a second housing portion 22 connected by bolts, which accommodates the gear set of the transmission device 2, including: a differential, intermediate gears, etc. In the illustrated embodiment, the first housing portion 21 and the second housing portion 22 are roughly herringbone-shaped, in order to define a herringbone-shaped cavity to accommodate the roughly herringbone-shaped transmission gear set. The first brake motor 11 and the second brake motor 12 are mounted on the first housing portion 21, and pinions 111, 121 connected to their output shafts extend into the interior cavity and engage with the corresponding intermediate gears 201, 202. Therefore, the first brake motor 11, the second brake motor 12 and the brake actuator 3 according to the embodiment are located on the same side of the transmission device 2, resulting in a relatively smaller axial length of the electromechanical brake so that it can be arranged in the compact space on the inner side of the wheel hub, while still providing sufficient brake torque in the presence of dual-brake motor system. In some embodiments, magnet portions 112 and 122 of the rotary position sensors are set up on the output shafts of the first brake motor 11 and the second brake motor 12. Furthermore, corresponding detectors 112′ and 122′ of the rotary position sensors, such as Hall sensors (FIG. 13), are set up on a circuit board at positions corresponding to the magnet portions 112 and 122, to detect changes in the magnetic fields generated by the magnet portions 112 and 122, thus sensing the phase and rotational speed of the first brake motor 11 and the second brake motor 12. The second housing portion 22 further provides an interface 221 for connecting to the vehicle's controller, such as the electronic control unit (ECU), thereby realizing communication between the electromechanical brake and the ECU, allowing the ECU to control the first brake motor 11 and the second brake motor 12, and capture the status of the brake motor through the rotary position sensor. Additionally, a total output torque sensor 81 (which can be arranged at the screw nut device of the brake actuator 3) and current sensors 82 and 83 corresponding to motors 11 and 12 respectively may be set up, thus transmitting the total output torque of the electromechanical brake and the currents of the first brake motor 11 and the second brake motor 12 to the ECU. With the above arrangements, the rotary position sensors send feedback on the rotational state of the motor's rotor to the ECU, while the torque and current sensors send feedback on the clamping torque and operating currents of motors to the ECU. ECU controls the first brake motor and the second brake motor based on the rotational speeds and currents of the first brake motor and the second brake motor, respectively.

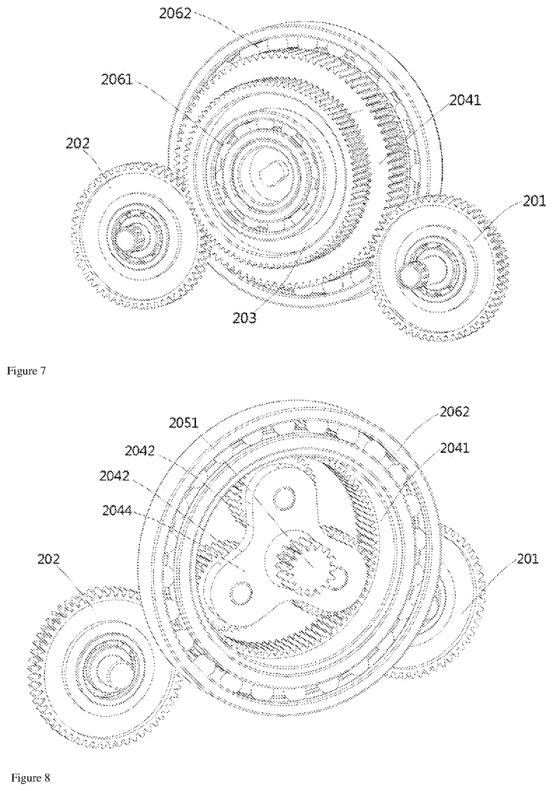

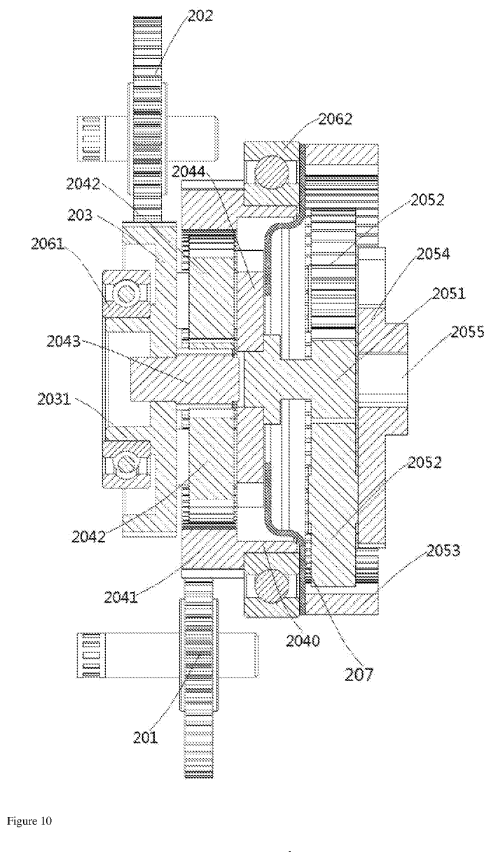

In the embodiments of the present disclosure, the transmission device 2 includes a differential, which is coupled to the first brake motor 11 and the second brake motor 12 respectively to receive the input torques of the first brake motor 11 and the second brake motor 12, and outputs the integrated torque to the brake actuator 3. In some embodiments, the differential is a planetary differential system. In some embodiments, the planetary differential system includes: a first ring gear 2041, a first sun gear 2043 and a plurality of first planetary gears 2042 between the first ring gear 2041 and the first sun gear 2043, the first brake motor 11 being coupled to the outer teeth of the first ring gear 2041, the second brake motor 12 being coupled to the first sun gear 2043, and a plurality of first planetary gears 2042 being linked to a first planetary carrier 2044. In some embodiments, the transmission device further includes a first intermediate gear 201, a second intermediate gear 202, and a coaxial gear 203. As shown in FIG. 6, the first intermediate gear 201 engages with the gear 111 on the output shaft of the first brake motor 11 and the outer teeth of the first ring gear 2041 respectively. The second intermediate gear 202 engages with the gear 121 on the output shaft of the second brake motor and the coaxial gear 203 respectively. As shown in FIG. 10, the coaxial gear 203 is coaxially coupled to the first sun gear 2043; for example, as shown in the figure, the two are connected to rotate coaxially together, or alternatively, the two can be integrated. As shown in FIG. 10, in some embodiments, the coaxial gear 203 includes an axially extending portion 2031 rotatably supported by the first bearing 2061, and the first ring gear 2041 includes an axially extending portion 2040 rotatably supported by the second bearing support 2062. The first bearing 2061, for example, may be mounted in the housing, and the second bearing 2062, for example, may be mounted in the housing and/or supported by the intermediate bracket 207.

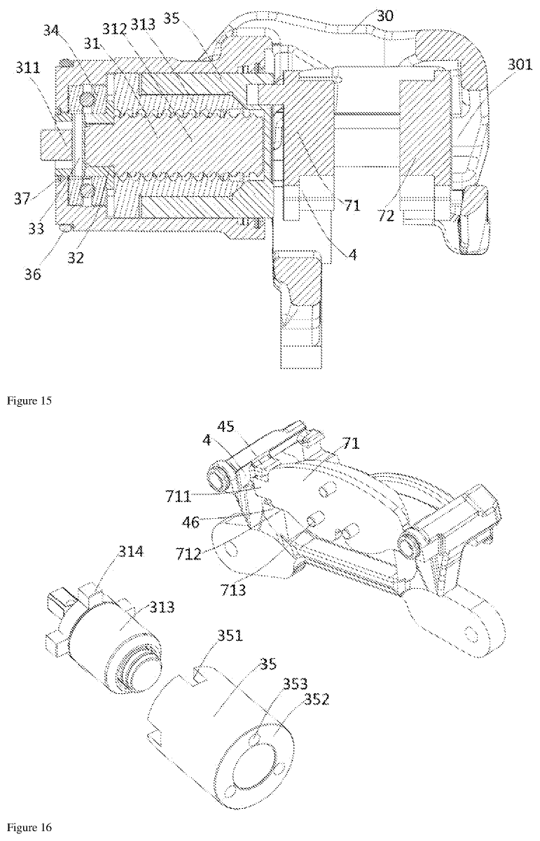

In some embodiments, the transmission device 2 further includes a second planetary gear set 205, which is separated from the above-mentioned differential and intermediate gear through an intermediate bracket 207, and the second planetary gear set includes: a second sun gear 2051, a second ring gear 2053, and a plurality of second planetary gears 2052 between the second sun gear 2051 and the second ring gear 2053, wherein the second sun gear 2051 is coaxially coupled to the first planetary carrier 2044 to receive the rotational torque of the first planetary carrier 2044, the second ring gear 2053 may be fixed, the second planetary carrier 2054 is linked to a plurality of second planetary gears 2052, and the second planetary carrier includes a core hole 2055, which may have a square cross-section or other non-circular cross-section, thereby connecting to the input end 311 (FIG. 15) of the brake actuator, to output torque to the brake actuator 3. It should be understood that the second planetary gear set 205 mainly serves a role in increasing torque. In some embodiments, the second planetary gear set 205 may be omitted, allowing the first planetary carrier 2044 to be directly connected to the input end 311 of the brake actuator 3.

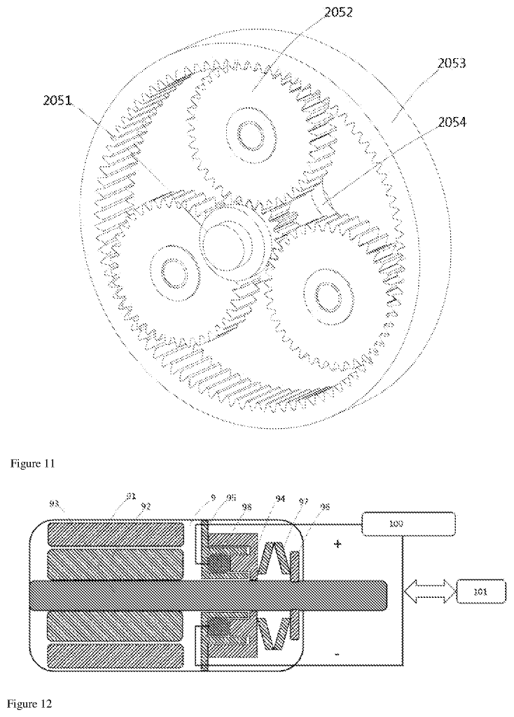

FIG. 12, as the further reference, shows an internal structural diagram of the brake motor according to the embodiment. Due to the use of a differential, in order to avoid the brake torque being transmitted to the unpowered brake motor, causing it to spin idly when the first brake motor 11 or the second brake motor 12 loses power, resulting in insufficient torque being transmitted to the brake actuator 3, the first brake motor 11 and the second brake motor 12 in the present application are each fitted with a self-locking device. In some embodiments, the self-locking device and the corresponding brake motor are powered by the same power source 100, and the self-locking device arrests the rotation of the corresponding brake motor when the power is lost, thereby locking the brake motor that has lost power, allowing the other functioning brake motor to still output brake torque to the brake actuator 3. In some embodiments, as shown in FIG. 12, the brake motor includes a housing 9, a stator 91 inside the housing, a rotor 92 inside the stator 91, and a rotor shaft or output shaft 93 linked to the rotor 92. The self-locking device includes: a rotary disc 94 connected to the corresponding motor output shaft 93, capable of rotating together with the output shaft 93 and moving axially relative to the rotor shaft 93, for example, the rotor shaft 93 having one or more keys to rotate together with the rotary disc 94; a fixed friction disc 95, for example, fixed to the motor housing 9; a spring 97 tending to push the rotary disc 94 towards the brake disc 95 to brake the rotary disc 94; and an electromagnetic coil 98 that generates a magnetic field when power is on to produce magnetic force to overcome the thrust of spring 97, and generates a magnetic field when powered by power source 100 to overcome the thrust of spring 97 and pushes the rotary disc 94 to the right away from the friction disc 95, thereby allowing the output shaft 93 to rotate freely, and when the power source 100 is no longer powered due to a fault, the rotary disc 94 engages with the friction disc 95, preventing the motor's rotor shaft 93 from idling. In addition, the power source 100 is further connected to the electronic control unit 101.

As shown in FIG. 13, the electromechanical brake further includes a circuit board 8, which is not visually shown in the figure though, it is connected to an external device through the interface 221. The circuit board 8 is connected to the first brake motor 11, the second brake motor 12, detectors 112′ and 122′ of sensors for detecting the rotary positions of the first brake motor 11 and the second brake motor 12, current sensors 81 and 82 for detecting the currents of the first brake motor 11 and the second brake motor 12, and the total output torque sensor 83 respectively, thereby exchanging various data and control signals with the control system.

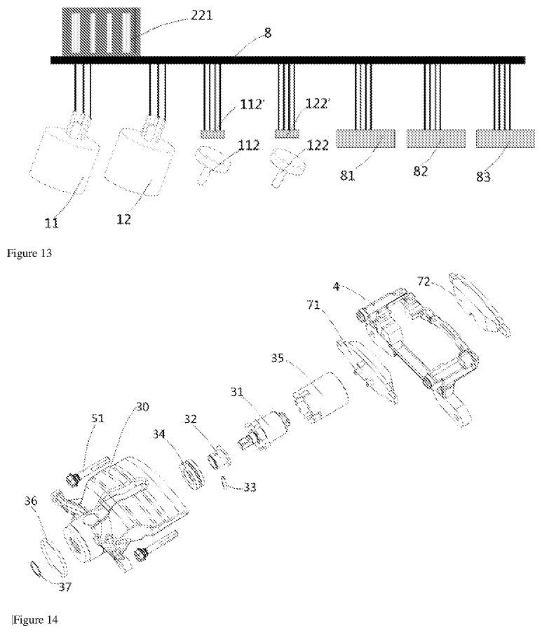

The brake actuator according to the embodiment is hereby described in detail with further reference to FIGS. 14 and 15. The brake actuator includes a brake actuator housing 30, which accommodates a screw nut mechanism 31 and a plunger 35. In the illustrated embodiment, the screw of the screw nut mechanism includes an input end 311, which is used to connect to the transmission device, and a screw body 312 that fits in with the nut 313. The input end 311, for example, has a cross-sectional shape such as a square, which matches the core hole 2055 of the second planetary carrier to receive torque. Additionally, a sealing ring 36 is provided for sealing between the brake actuator and the transmission device. The input end 311 fits in with a support ring 32 arranged on its outer periphery via a pin 33. In one aspect, the support ring 32 is supported against the rear side of the screw body 312 and in one aspect, it is limited axially by a snap ring 37, thus being axially limited but able to rotate together with the screw. The support ring 32 is supported by a bearing 34. In some embodiments, the bearing 34 is a thrust bearing. Alternatively, the bearing 34 can be a deep groove ball bearing, an angular contact ball bearing, or a center ball bearing, among others. Alternatively, the screw can be supported directly by the bearing.

In some embodiments, the nut 313 of the screw nut mechanism is coupled to the plunger 35 in the circumferential direction. For example, the outer side of the nut 313 may have grooves or protrusions that correspondingly fit in with protrusions or grooves on the plunger 35. In some embodiments, the plunger 35 is coupled to the friction disc 71 in the circumferential direction. For example, the front face of the plunger 35 may have grooves or protrusions along the axial direction that correspondingly fit in with protrusions or grooves on the friction disc 71. Furthermore, the friction disc 71 is supported by a friction disc bracket 4, which limits the circumferential movement of the friction disc 71. As a result, both the plunger 35 and the nut 313 are restricted in the circumferential direction, allowing only axial movement and preventing circumferential rotation, thereby realizing circumferential limitation and axial movement of the nut 313 in the screw nut mechanism. Thus, by utilizing the circumferential coupling between the nut and the plunger, and the plunger and the friction disc, as well as the circumferential limitation imposed by the friction disc bracket 4 on the friction disc 71, it is unnecessary to set up features in the housing specifically aimed at limiting the nut's circumferential movement.

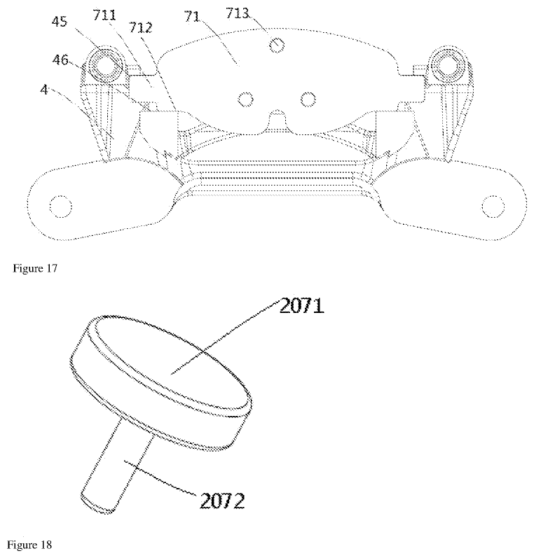

The specific structures of the nut, plunger, friction disc, and friction disc bracket according to one embodiment are hereby described with further reference to FIGS. 16 and 17. In some embodiments, the outer ring of the nut 313 has a plurality of keys 314, the plunger 35 has a sleeve portion mounted on the outer ring of the nut 313 in a sleeved manner, and the rear side of the sleeve portion has a plurality of slots 351 that fit in with the a plurality of keys 314, realizing the circumferential coupling of the two through the mating of the plurality of keys 314 of the nut 313 and the plurality of slots 351 of the sleeve portion of the plunger 35. In some embodiments, the front face 352 of the sleeve portion has a plurality of grooves 353, and the adjacent surface of the friction disc 71 facing the front face 352 of the sleeve portion has a corresponding plurality of protrusions 713, realizing the circumferential coupling of the two through the mating of plurality of grooves 353 on the front face 352 of the nut with the plurality of protrusions 713 on the friction disc 71. It should be understood that the nut 313, plunger 35, and friction disc 71 are not axially coupled to each other; therefore, they can have axial displacement relative to one another. However, the plurality of keys 314, plurality of slots 351, plurality of grooves 353, and plurality of protrusions 713 should be set up with sufficient axial length to prevent the disengagement of the nut 313, plunger 35, and friction disc 71 from each other during axial displacement.

It should be understood that the above-mentioned nut 313, plunger 35, and friction disc 71 may also be designed to be axially coupled to each other, for example, by making the nut 313, plunger 35, and friction disc 71 axially coupled through an interference fit, the nut 313, plunger 35, and friction disc 71 can axially move simultaneously.

In some embodiments, the friction disc 71 is fitted with ears 711 on both ends, and the friction disc 71 is circumferentially limited by inserting the ears 711 into the side grooves 45 of the friction disc bracket 4. In some embodiments, there may be a gap between the ears 711 of the friction disc 71 and the grooves 45 of the friction disc bracket 4, with damping return springs being set up. In this case, the friction disc 71 further includes shoulders 712 on the inner side of the ears, and the friction disc bracket 4 further includes a pair of protrusions 46 supporting the shoulders 712 at the two ends of the friction disc, thereby realizing the circumferential limitation of the friction disc 71, while allowing the friction disc 71 to axially move relative to the friction disc bracket 4. It should be understood that, as shown in FIG. 15, an opposed friction disc 72 is further set up on the friction disc bracket 4, which is arranged opposite to the friction disc 71. The opposed friction disc 72 has a similar shape to the friction disc 71 (but without the need of features for fitting in with the plunger) and can be arranged to move axially in a similar manner on the friction disc bracket 4. As described earlier, the brake actuator housing 30 is floatingly mounted on the friction disc bracket 4 via an axial guide rod 51. The assembled electromechanical brake is fixed to the steering knuckle arm 93 via a flange 43 on the friction disc bracket 4, so that the friction disc 71 and the opposed friction disc 72 are located on both sides of the brake disc 95. During the establishment of the torque, the rotation of the brake motor drives the transmission device 2, causing the rotation of the screw nut's screw, the translation of the nut, and the movement of the plunger, thereby bringing the friction disc 71 into contact with the brake disc 95. Additionally, since the brake disc 95 and the friction disc bracket 4 are fixed, the reaction force on the screw 312 is transferred to the brake actuator housing 30 of the electromechanical brake when the nut 313 is translated, causing the brake actuator housing 30 to move in reversely (toward the left as shown in FIG. 15). The hook portion 301 of the brake actuator housing will drive the opposed friction disc 72 to move axially to the left, clamping the brake disc 95 together with the friction disc 71. When the brake torque is released, the rotation of the brake disc 95 pushes away the friction disc 71 and the opposed friction disc 72, providing enough clearance to allow the brake disc 95 to rotate freely until the next braking cycle.

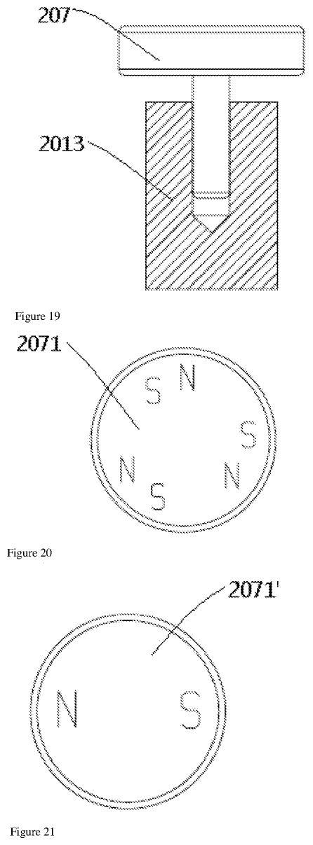

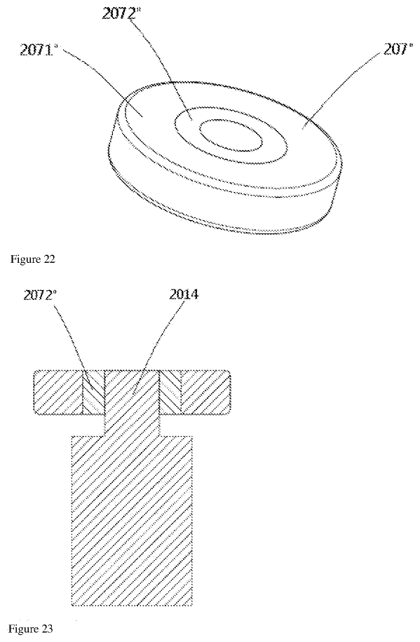

FIGS. 18 to 21, as the further reference, show the structure of the rotary position sensor magnet. In this embodiment, the magnet 207 includes a disc-shaped magnet portion 2071 and a shaft portion 2072. The shaft portion 2072 is mounted in the shaft hole of the gear shaft or motor shaft 2013, and the disc-shaped magnet portions 2071, 2071′ include one or more pairs of magnetic poles spaced 180 degrees apart. FIGS. 22 to 23, as the further reference, show another structure of the rotary position sensor magnet 207″, including an annular magnet portion 2071″ and a shaft washer 2072″ on the inner side of the annular magnet portion 2071″. The rotary position sensor magnet is mounted on the protruding end 2014 of the gear shaft or motor shaft via the shaft washer 2072″. Similarly, the annular magnet portion 2071″ may include one or more pairs of magnetic poles spaced 180 degrees apart. As described above, the rotary position sensor magnet may be mounted on the output shaft of the two brake motors, or the intermediate gear using any of the above-mentioned methods or other suitable methods.

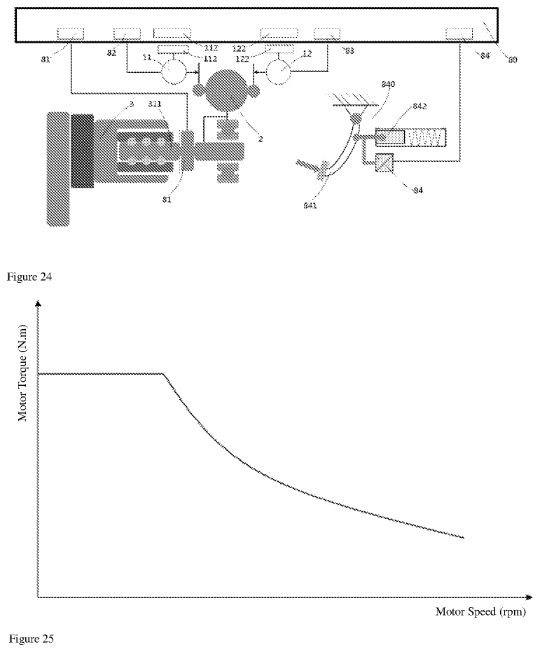

The electromechanical brake system according to the embodiment is hereby described with further reference to FIG. 24. The control system includes a controller 80, which is, for example, the electronic control unit (ECU) of a vehicle. The ECU obtains the operating state, i.e., the rotational speed and phase, of the first brake motor 11 and the second brake motor 12 through the rotary position sensors. The ECU further obtains the operating currents of the first brake motor 11 and the second brake motor 12 through the current sensors 82 and 83, respectively. Additionally, the ECU obtains the displacement of the brake pedal 841 by using a pedal displacement sensor 84 in the brake pedal device 840. The displacement of the brake pedal 841 is sent to a pedal displacement receiver 84′. Moreover, the brake pedal device 840 further includes a pedal feel simulation device 842. Furthermore, the ECU obtains the total output torque of the coupled first brake motor and second brake motor through a torque sensor 81, for example, the total output torque of the first brake motor 11 and the second brake motor 12 transmitted to the brake actuator system 3 through the transmission device 2 in a coupling manner. For instance, the torque sensor 81 is set up between the transmission device 2 and the brake actuator 3 (or in the brake actuator 3) to sense the torque at the input end 311 of the brake actuator system 3 and sends it to the brake torque receiver 81′. In an alternative embodiment, the total brake torque may be measured at any suitable position, for example, between the differential system and the input shaft of the brake actuator.

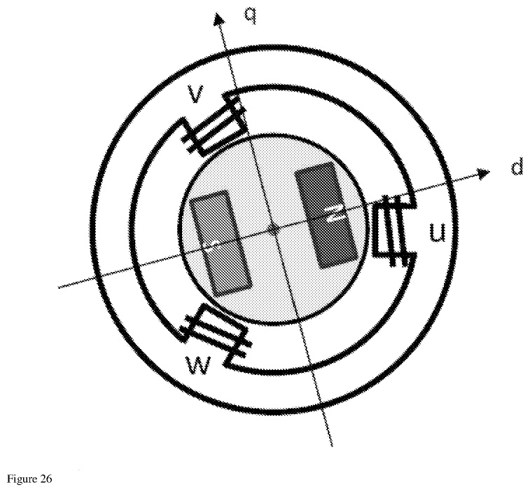

FIG. 25, as the further reference, shows an exemplary motor characteristic curve. The motor characteristic curve corresponds to specific currents. The characteristic curves of each motor at various currents can be obtained by conducting motor performance tests or through calculations. In this curve, when the motor speed is lower than or equal to a specific value, the motor output torque remains substantially constant, and when the motor speed is higher than the specific value, the motor output torque decreases with an increase in motor speed.

FIG. 26, as the further reference, shows a cross-sectional view of an exemplary motor. For motors of this type, the motor output torque T can be calculated, for example, using the following equation:

$$T = \frac{3}{2} P ( Ψ + ( {L}_{d} - {L}_{q} ) {I}_{d} ) {I}_{q}$$

where, T: Motor output torque; P: Number of rotor pole pairs; Ψ; Main magnetic flux (main magnetic chain); L_{d}: d-axis inductance; L_{q}: q-axis inductance; I_{d}: Current in the stator that generates magnetic flux parallel to the main magnetic flux; I_{q}: Current producing the magnetic flux perpendicular to the main flux in the stator. The above method of calculating torque is merely illustrative, and in an alternative embodiment, various other suitable methods can be used to calculate the output torque of each motor.

The specific embodiments described above in the present application are intended to only describe the principles of the present application more clearly, i.e. clearly illustrate or describe various components to make the principles of the present disclosure easier to understand. Within the scope of the present application, those skilled in the art can easily make various modifications or changes to the present application. Therefore, it should be understood that these modifications or changes are all included within the scope of the patent protection of the present application.

What is claimed is:

1. An electromechanical brake, comprising:
a first brake motor and a second brake motor;
a transmission device linked to the first brake motor and the second brake motor; and
a brake actuator linked to the transmission device, with the transmission device configured to transmit a first brake torque from the first brake motor and a second brake torque from the second brake motor to the brake actuator;
wherein
the transmission device comprises a differential coupled to the first brake motor and the second brake motor respectively to receive the first and second brake torques, and output an integrated torque to the brake actuator.

2. The electromechanical brake according to claim 1, wherein the differential is a planetary differential system.

3. The electromechanical brake according to claim 2, wherein:
the planetary differential system comprises:
a first ring gear,
a first sun gear, and
a plurality of first planetary gears between the first ring gear and the first sun gear;
the first brake motor is coupled to outer teeth of the first ring gear;
the second brake motor is coupled to the first sun gear; and
the plurality of first planetary gears is linked to a first planetary carrier.

4. The electromechanical brake according to claim 3, wherein:
the transmission device further comprises
a first intermediate gear,
a second intermediate gear, and
a coaxial gear;
the first intermediate gear is engaged with an output shaft of the first brake motor and the outer teeth of the first ring gear;
the second intermediate gear is engaged with an output shaft of the second brake motor and the coaxial gear; and
the coaxial gear is coaxially coupled to the first sun gear.

5. The electromechanical brake according to claim 3, wherein the coaxial gear and the first ring gear each comprise a respective axially extending portion configured to be supported by a first bearing and a second bearing, respectively.

6. The electromechanical brake according to claim 3, wherein:
the transmission device further comprises a second planetary gear set;
the second planetary gear set comprises
a second sun gear,
a second ring gear, and
a plurality of second planetary gears between the second sun gear and second ring gear;
the second sun gear is coaxially coupled to the first planetary carrier;
the second ring gear is fixed;
the second planetary carrier is linked to the plurality of second planetary gears; and
the second planetary carrier comprises a core hole configured to output torque to the brake actuator.

7. The electromechanical brake according to claim 1, wherein:
the first brake motor and the second brake motor are each fitted with a respective self-locking device;
the respective self-locking devices and the corresponding brake motor are powered by the same power source; and
the respective self-locking devices are configured to arrest rotation of the corresponding brake motor when the power supply is lost.

8. The electromechanical brake according to claim 7, wherein each of the respective self-locking devices comprise:
a rotary disc connected to the corresponding motor output shaft;
a fixed friction disc;
a spring configured to push the rotary disc against the friction disc to brake the rotary disc; and
an electromagnetic coil configured to generate a magnetic field when power is on, which applies a magnetic force to the rotary disc, allowing it to overcome the thrust of the spring and move away from the friction disc.

9. The electromechanical brake according to claim 1, wherein the electromechanical brake further comprises:
a first rotational speed sensor and a second rotational speed sensor configured to detect rotational speeds of the first brake motor and the second brake motor, respectively;
a first current sensor and a second current sensor configured to detect currents of the first brake motor and the second brake motor, respectively; and
a controller configured to control the first brake motor and the second brake motor based on the rotational speeds and currents of the first brake motor and the second brake motor.

10. A vehicle, comprising the electromechanical brake according to claim 1.
